(19) United States
(12) Patent Application Publication
(10) Pub. No.: US 2008/0126771 A1
(43) Pub. Date: May 29, 2008

(54) Branch Target Extension for an Instruction Cache

(76) Inventors: Lei Chen, Austin, TX (US); Zhigang Hu, Ossining, NY (US); Lixin Zhang, Austin, TX (US)

Correspondence Address: IBM CORP (WSM);C/O WINSTEAD SECHREST & MINICK P.C., PO BOX 50784, DALLAS, TX, 75201, US

(21) Appl. No.: 11/459,683

(22) Filed: Jul. 25, 2006

(51) Int. Cl. G06F 9/38

(52) U.S. Cl. 712/238; 712/E09.055

(57) ABSTRACT

An instruction cache (I-Cache) for a processor is configured to include a Branch Target Extension associated with each Instruction Sector. When an Instruction Sector is fetched, the Branch Target Extension is simultaneously fetched. If the Instruction Sector has a branch instruction that is predicted taken, then the branch target address in the branch extension is used to access the next Instruction Sector. In other embodiments, each Instruction Sector has a plurality of Branch Target Extensions each corresponding to a potential branch instruction in an Instruction Sector. In this case, the Branch Target Extensions are partitioned into an instruction index field for locating branch instruction in the Instruction Sector, a local predictor field for predicted taken status and a target address field for the branch target address. The least significant bits of the instruction fetch address are compared to the instruction indexes to determine a particular Branch Target Extension to use.

### TECHNICAL FIELD

The present invention relates in general to methods and circuitry for improving processor performance by reducing delays in handling branch instruction execution.

### BACKGROUND INFORMATION

For a long time, the secret to more performance was to execute more instructions per cycle, otherwise known as Instruction Level Parallelism (ILP), or decreasing the latency of instructions. To execute more instructions each cycle, more functional units (e.g., integer, floating point, load/store units, etc.) have to be added. In order to more consistently execute multiple instructions, a processing paradigm called out-of-order processing (OOP) may be used, and in fact, this type of processing has become mainstream.

OOP arose because many instructions are dependent upon the outcome of other instructions, which have already been sent into the processing pipeline. To help alleviate this problem, a larger number of instructions are stored in order to allow immediate execution. The reason this is done is to find more instructions that are not dependent upon each other. The area of storage used to store the instructions that are ready to execute immediately is called the reorder buffer. The size of reorder buffers has been growing in most modern commercial computer architectures with some systems able to store as many as 126 instructions. The reason for increasing the size of the reorder buffer is simple: code that is spatially related tends also to be temporally related in terms of execution. The only problem is that these instructions also have a tendency to depend upon the outcome of prior instructions. With a CPU's design goal of ever increasing instruction level parallelism (ILP), one way to find more independent instructions has been to increase the size of the reorder buffer.

However, using this technique has achieved a rather impressive downturn in the rate of increased performance and in fact has been showing diminishing returns. It is now taking more and more transistors to achieve the same rate of performance increase. Instead of focusing intently upon uniprocessor ILP extraction, one can focus upon a coarser form of extracting performance at the instruction or thread level, via multithreading (multiprocessing), but without the system bus as a major constraint.

The ability to put more transistors on a single chip has allowed on-chip multiprocessing (CMP). To take advantage of the potential performance increases, the architecture cannot use these multiple processors as uniprocessors but rather must use multiprocessing that relies on executing instructions in a parallel manner. This requires the programs executed on the CMP to also be written to execute in a parallel manner rather than in a purely serial or sequential manner. Assuming that the application is written to execute in a parallel manner (multithreaded), there are inherent difficulties in making the program written in this fashion execute faster proportional to the number of added processors.

The general concept behind using multiple cores on one die is to extract more performance by executing two or more threads at once. By doing so, the multiple CPUs simultaneously are able to keep a higher percentage of the aggregate number of functional units doing useful work at all times. If a processor has more functional units, then a lower percentage of those units may be doing useful work at any one time. The on-chip multiprocessor lowers the number of functional units per processor, and distributes separate tasks (or threads) to each processor. In this way, it is able to achieve a higher throughput on tasks combined. A comparative uniprocessor would be able to get through one thread, or task, faster than a CMP chip could, because, although there are wasted functional units, there are also “bursts” of activity produced when the processor computes multiple pieces of data at the same time and uses all available functional units. One idea behind multiprocessors is to keep the individual processors from experiencing such burst activity times and instead have each processor use what resources it has available more frequently and therefore efficiently. The non-use of some of the functional units during a clock cycle is known as “horizontal waste,” which CMP tries to avoid.

However, there are problems with CMP. The traditional CMP chip sacrifices single-thread performance in order to expedite the completion of two or more threads. In this way, a CMP chip is comparatively less flexible for general use, because if there is only one thread, an entire half of the allotted resources are idle and completely useless Oust as adding another processor in a system that uses a singly threaded program is useless in a traditional multiprocessor (MP) system). One approach to making the functional units in a CMP more efficient is to use course-grained multithreading (CMT). CMT improves the efficiency with respect to the usage of the functional units by executing one thread for a certain number of clock cycles and then switching to another thread. The efficiency is improved due to a decrease in “vertical waste.” Vertical waste describes situations in which none of the functional units are working due to one thread stalling.

When switching to another thread, the processor saves the state of the current thread and switches to another thread. It does so by using multiple register sets. The advantage of this is due to the fact that often a thread can only go for so long before it falls upon a cache miss, or runs out of independent instructions to execute. A CMT processor can only execute as many different threads in this way for which it has support. That is, a CMT processor can only store as many threads as there are physical locations for each of these threads to store the state of their execution.

A variation on this concept would be to execute one thread until it has experienced a cache miss (usually an L2 (secondary) cache miss), at which point the system would switch to another thread. This has the advantage of simplifying the logic needed to rotate the threads through a processor, as it will simply switch to another thread as soon as the prior thread is stalled. The penalty of waiting for a requested block to be transferred back into the cache is then alleviated. This is similar to the hit under miss (or hit under multiple miss) caching scheme used by some processors, but it differs in that it operates on threads instead of upon cache requests. The advantages of CMT over CMP are CMT does not sacrifice single-thread performance, and there is less hardware duplication (less hardware that is divided into groups to make the processors “equal” to a comparable CMT).

A more aggressive approach to multithreading is called fine-grained multithreading (FMT). Like CMT, the basis of FMT is to switch rapidly between threads. Unlike CMT, however, the idea is to switch each and every cycle. While both CMT and FMT actually do indeed slow down the completion of one thread, FMT expedites the completion of all the threads being worked on, and it is overall throughput which generally matters most.

CMPs may remove some horizontal waste in and unto themselves. CMT and FMT may remove some (or all) vertical waste. However an architecture that comprises an advanced form of multithreading, referred to as Simultaneous Multithreading (SMT), may be used to reduce both horizontal and vertical waste. The major goal of SMT is to have the ability to run instructions from different threads at any given time and in any given functional unit. By rotating through threads, an SMT architecture acts like an FMT processor, and by executing instructions from different threads at the same time, it acts like CMP. Because of this, it allows architects to design wider cores without the worry of diminishing returns. It is reasonable for SMT to achieve higher efficiency than FMT due to its ability to share “unused” functional units among different threads; in this way, SMT achieves the efficiency of a CMP machine. However, unlike a CMP system, an SMT system makes little to no sacrifice (the small sacrifice is discussed later) for single threaded performance. The reason for this is simple. Whereas much of a CMP processor remains idle when running a single thread and the more processors on the CMP chip makes this problem more pronounced, an SMT processor can dedicate all functional units to the single thread. While this is obviously not as valuable as being able to run multiple threads, the ability to balance between single thread and multithreaded environments is a very useful feature. This means that an SMT processor may exploit thread-level parallelism (TLP) if it is present, and if not, will give full attention to instruction level parallelism (ILP).

In order to support multiple threads, an SMT processor requires more registers than the traditional superscalar processor. The general aim is to provide as many registers for each supported thread as there would be for a uniprocessor. This implies that a traditional reduced instruction set computer (RISC) chip requires 32 times N registers (assuming 32 architectural registers and N is the number of threads an SMT processor could handle in one cycle) plus whatever renaming registers, other registers including system registers, etc. that are required. Therefore, a 4-way SMT processor RISC processor requires 128 registers plus whatever renaming registers, other registers including system registers, etc. that are needed.

Most SMT models are straightforward extensions of a conventional out-of-order processor. With an increase in the actual throughput comes higher demands upon instruction issue width, which should be increased accordingly. Because of the aforementioned increase in the register file size, an SMT pipeline length may be increased by two stages (one to select register bank and one to do a read or write) so as not to slow down the length of the clock cycle. The register read and register write stages are therefore both broken up into two pipelined stages.

In order to not allow any one thread to dominate the pipeline, an effort should be made to ensure that the other threads get a realistic slice of the execution time and resources. When the functional units are requesting work to do, the fetch mechanism will provide a higher priority to those threads that have the fewest instructions already in the pipeline. Of course, if the other threads have little they can do, more instructions from the thread are already dominating the pipelines.

SMT is about sharing whenever possible. However, in some instances, this disrupts the traditional organization of data, as well as instruction flow. The branch prediction unit becomes less effective when shared, because it has to keep track of more threads with more instructions and will therefore be less efficient at giving an accurate prediction. This means that the pipeline will need to be flushed more often due to mispredictions, but the ability to run multiple threads more than makes up for this deficit. However, this will be design and application dependent. More threads means more instruction fetching and thus more branch instructions. This will put a larger pressure on the front-end, including the branch predictor. Potentially, the aliasing problem will be more severe which will directly affect performance. Furthermore, SMT may potentially increase the branch penalty, i.e., the number of cycles between branch prediction and branch execution, which in turn will decrease performance.

The penalty for a misprediction is greater due to the longer pipeline used by an SMT architecture (by two stages), which is in turn due to the rather large register file required. However, techniques have been developed to minimize the number of registers needed per thread in an SMT architecture. This is done by more efficient operating system (OS) and hardware support for better deallocation of registers, and the ability to share registers from another thread context if another thread is not using all of them.

Another issue is the number of threads in relation to cache sizes, the cache line sizes, and their bandwidths. As is the case for single-threaded programs, increasing the cache-line size may decrease the miss rate but also may increase the miss penalty. Having support for more threads which use more differing data exacerbates this problem and thus less of the cache is effectively useful for each thread. This contention for the cache is even more pronounced when dealing with a multiprogrammed workload over a multithreaded workload. Thus, if more threads are in use, then the caches should be larger. This also applies to CMP processors with shared L2 caches.

The more threads that are in use results in a higher overall performance and the differences in association of memory data become more readily apparent. There is an indication that when the L1 (primary) cache size is kept constant, the highest level of performance is achieved using a more associative cache, despite longer access times. Tests have been conducted to determine performance with varying block sizes that differ associatively while varying the numbers of threads. As before, increasing the associative level of blocks increased the performance at all times; however, increasing the block size decreased performance if more than two threads were in use. This was so much so that the increase in the degree of association of blocks could not make up for the deficit caused by the greater miss penalty of the larger block size.

An SMT processor has various elements that are broadly termed resources. A resource may be an execution unit, a register rename array, a completion table, etc. Some resources are thread specific, for example each thread may have its own instruction queue where instructions for each thread are buffered. Execution units are shared resources where instructions from each thread are executed. Likewise a register rename array and a completion table in a completion unit may be shared resources. If the entries in a shared register rename array are mostly assigned to one thread then that thread may be using an excessive amount of this shared resource. If the other thread needs a rename register to proceed, then it may be blocked due to lack of a resources and may be restricted from dispatch. Other elements in a system that comprises an SMT processor may be termed resources and may not apply to the problems addressed by the present invention if those resources do not slow execution of instructions from multiple threads.

In an SMT processor, there may be an in-order shared pipeline that is part of a larger pipelined process for doing out-of-order instruction execution in multiple execution units. For example, instructions from two threads may be alternately loaded into a shared pipeline comprising an instruction fetch unit (IFU) and instruction dispatch unit (IDU). The instruction fetch addresses are alternately loaded into an instruction fetch address register (IFAR) in the IFU. In this case, it is possible for one thread in the shared pipeline to be “stalled” and thus block the other thread from progressing through the pipeline. There are additional conditions where a first instruction of a first thread generates an exception condition during execution that needs an exception address from a following second instruction of the same first thread that has not reached dispatch to resolve the exception condition. If the first instruction generating the exception condition has shared resources that it needs to release to allow blocking instruction from a second thread to dispatch before the second instruction can proceed to dispatch, then the shared pipeline may be additionally blocked.

I-Cache is a buffer memory between external memory and the core processor. When code executes, the code words at the locations requested by the program execution are copied into I-Cache for direct access by the core processor. If the same code is used frequently in a set of program instructions, storage of these instructions in the I-Cache yields an increase in throughput because the external bus accesses are eliminated. The I-Cache may also feature configurations that allow instructions to be sectored to better manage instruction flow. Groups of instructions may be loaded from external memory because of the fact that during instruction execution the next instruction needed is usually close to the present instruction.

Instruction fetch has been a bottleneck for modern high performance processors. The problem derives from the branch instructions for controlling the program execution flow. In a branching situation, if a first condition is met then a branch is taken to another part of the program, otherwise the next instruction in a sequence is executed. There is usually no pipeline delay for instruction fetch if the branch falls through (next sequential instruction executed). However, when the branch is taken, instruction fetch needs to start from a new address which usually involves some delay.

Numerous solutions have been proposed to alleviate the above mentioned problem. A few are listed below along with their limitations:
Branch target buffer—a buffer searched using the branch instruction address, containing the target addresses for the branches, if they are taken. A separate structure and extra search logic are needed. It also consumes more power and is hard to accommodate multiple accesses.
Trace cache—an I-Cache which stores dynamic instruction sequences. Back-end trace BLDG LOGIC is needed. Relatively large overhead since the same instruction may appear in different races.
Link stack and count cache—used to predict the return branch target address and repetitive branch target address. Both need extra structures and control logic. The link stack also suffers from mispeculation.
Next line predictor—a mechanism for predicting a next instruction index to an instruction cache. Multiple structures are utilized for different purposes. Instead of updating with the branch instruction type, position, and target from later pipeline stages, it is proposed to move most to the pre-decode stage upon instruction loading from L2 into L1. Also lay out and design in the same configuration as the instruction cache, virtually creating an alias-free design (with the nearly perfect L1 instruction hit rate in most cases). Local branch predictions, those relying on single branches, may be done in an alias-free fashion and earlier in the pipeline.

The above mentioned solutions may also require the fetched instructions to be scanned to determine the branch instructions so that the branches and targets can be predicted using the branch address. There is, therefore, a need for a method that solves the bottleneck in instruction fetch resulting from branching instructions.

### SUMMARY OF THE INVENTION

A mechanism to extend the I-Cache with branch target addresses is implemented. A Branch Target Extension is added to each Instruction Sector in the I-Cache. The branch target address in the Branch Target Extension is updated if necessary after the branch target address calculation. For future fetch of the same Instruction Sector, the branch target address is known at fetch time. Therefore, if the branch instruction is predicted taken it may be used to fetch the next cache line.

Instruction fetch is not interrupted if there is no control flow (branch) instruction within the fetched group or the control flow instructions are known (or predicted) to be not taken. For taken branches, new instruction target addresses are needed by the instruction fetch engine. In a current architecture, a taken branch involves a 2-cycle delay to predict or calculate the fetch target address.

In one embodiment two or more Branch Target Extensions are added to each Instruction Sector each corresponding to a potential branch instruction in the Instruction Sector. The Branch Target Extensions are partitioned into three fields, instruction index field for storing the location of a branch instruction in the Instruction Sector, a local predictor field for storing a predicted taken status for a branch instruction, and the branch target address field for storing the target address for a branch instruction that is predicted taken. The instruction fetch address bits are compared to the instruction indexes to determine which Branch Target Extension contains a branch target address that is to be used for a particular branch instruction that is in the instruction flow and predicted taken. The local predictor field contains bits indicating if a branch is predicted taken or predicted not taken.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of functional units in an SMT processor suitable for practicing embodiments of the present invention;

FIG. 2A illustrates an I-Cache with multiple Instruction Sectors;

FIG. 2B illustrates the make-up of exemplary Instruction Sector in an I-Cache;

FIG. 3 illustrates an I-Cache with multiple Instruction Sectors according to embodiments of the present invention;

FIG. 4 illustrates an I-Cache with multiple Instruction Sectors according to another embodiment of the present invention;

FIG. 5 is a flow diagram of method steps used in embodiments of the present invention;

FIG. 6 is a flow diagram of method steps used in another embodiment of the present invention; and

FIG. 7 is a block diagram of a data processing system suitable for practicing embodiments of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits may be shown in block diagram form in order not to obscure the present invention in unnecessary detail. For the most part, details concerning timing, data formats within communication protocols, and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

In computer architecture, a branch target predictor is the part of a processor that predicts the target address of a conditional branch or unconditional jump instruction before the next instruction could be fetched from the I-Cache. The I-Cache is a specialized kind of CPU cache. Branch target address prediction is not the same as branch prediction. Branch prediction attempts to guess whether the branch will be taken or not.

In more recent parallel processor designs, as the I-Cache latency grows longer and the fetch width grows wider the process of branch target address extraction becomes a bottleneck. The recurrence may be as follows: Instruction cache fetches a block of instructions and the instructions in the block are scanned to identify branch instructions. The first predicted taken branch is identified, the target address of that branch is computed and then instruction fetch restarts at branch target address.

In machines where this recurrence takes two cycles, the machine loses one full cycle of fetch after every predicted taken branch. As taken branches happen every 10 instructions or so, this may force a substantial drop in instruction fetch bandwidth. Some machines with longer I-Cache latencies would have an even larger loss. To ameliorate the loss, some machines implement branch target address prediction: given the address of a branch, they predict the target address of that branch. A refinement of the idea predicts the start of a sequential run of instructions given the address of the start of the previous sequential group of instructions.

The above branch target predictor reduces the recurrence described to the following sequence: Hash the address of the first instruction in the group of instructions. Fetch the prediction for the addresses of the target addresses of branches in the group of instructions. Select the address corresponding to the branch predicted taken. As the branch predictor RAM may be 5-10% of the size of the I-Cache, the branch prediction fetch happens much faster than the I-Cache fetch, therefore it is much faster.

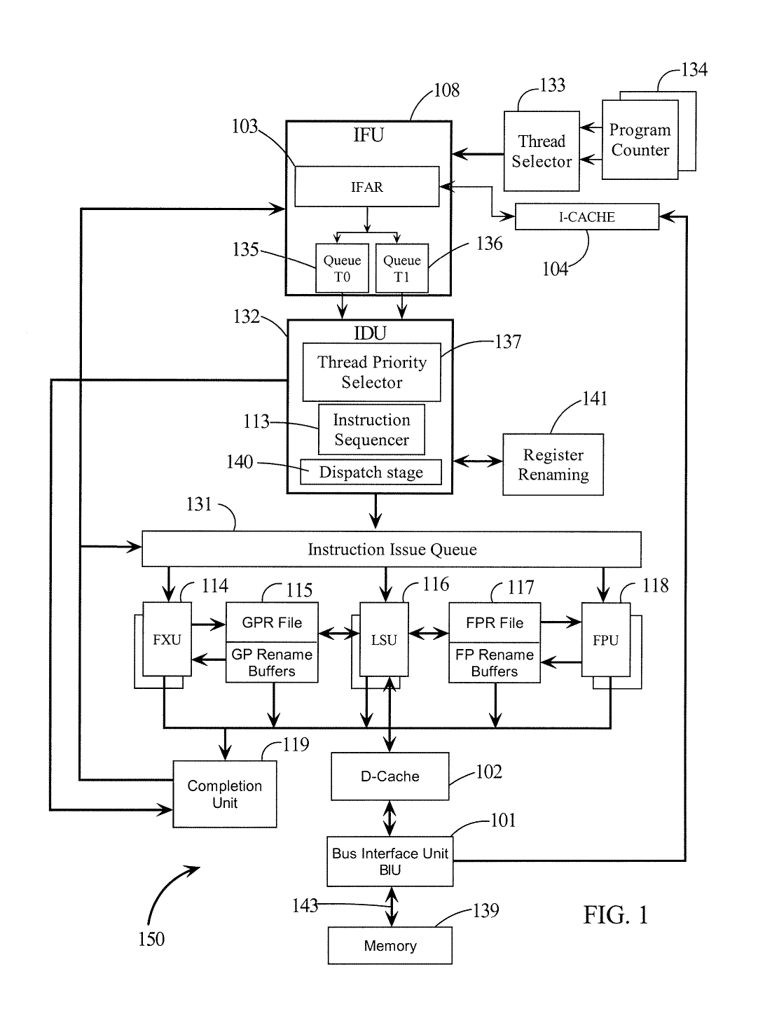

Referring to FIG. 1, there are illustrated details of a simultaneous multi-thread (SMT) central processing unit (CPU) 150 suitable for practicing embodiments of the present invention. CPU 150 is designed to execute multiple instructions per clock cycle. Thus, multiple instructions may be executed during any one clock cycle in any of the execution units, including fixed point units (FXUs) 114, floating point units (FPUs) 118, and load/store units (LSUs) 116. Likewise, CPU 150 may simultaneously execute instructions from multiple threads in an SMT mode.

Program counters (PCs) 134 correspond to thread zero (T0) and thread one (T1) that have instructions for execution. Thread selector 133 alternately selects between T0 and T1 to couple an instruction address to instruction fetch unit (IFU) 108. Instruction addresses are loaded into instruction fetch address register (IFAR) 103. IFAR 103 alternately fetches instructions for each thread from I-Cache 104. Instructions are buffered in instruction queue (IQ) 135 for T0 and IQ 136 for T1. IQ 135 and IQ 136 are coupled to instruction dispatch unit (IDU) 132. Instructions are selected and read from IQ 135 and IQ 136 under control of thread priority selector 137. Normally, thread priority selector 137 reads instructions from IQ 135 and IQ 136 substantially proportional to each thread's program controlled priority.

The instructions are decoded in a decoder (not shown) in IDU 132. Instruction sequencer 113 then may place the instructions in groups in an order determined by various algorithms. The groups of instructions are dispatched to instruction issue queue (IIQ) 131 by dispatch stage 140. The instruction sequencer 113 receives instructions from both threads in program order, but the instructions may be issued from the IIQ 131 out of program order and from either thread. The general purpose register (GPR) file 115 and floating point register (FPR) file 117 are used by multiple executing units and represent the program state of the system. These hardware registers may be referred to as the “physical” registers. When an instruction is dispatched to an issue queue, each architected register is renamed. Each architected register that is being modified is assigned a physical register and a corresponding look-up table identifies physical registers that are associated with an architected register. Therefore in the issue queues, the architected register has been renamed so that multiple copies of an architected register may exist at the same time. This allows instructions to be executed out-of-order as long as source operands are available. Register renaming unit 141, renames and maps the registers so that unused physical registers may be reassigned when all instructions referencing a particular physical register complete and the physical register does not contain the latest architected state.

Instructions are queued in IIQ 131 for execution in the appropriate execution unit. If an instruction contains a fixed point operation, then any of the multiple fixed point units (FXUs) 114 may be used. All of the execution units, FXU 114, FPU 118 and LSU 116 are coupled to completion unit 119 that has completion tables (not shown) indicating which of the issued instructions have completed and other status information. Information from completion unit 119 is forwarded to IFU 108. IDU 132 may also send information to completion unit 119. Data from a store operation from LSU 116 is coupled to data cache (D-Cache) 102. This data may be stored in D-Cache 102 for near term use and/or forwarded to bus interface unit (BIU) 101 which sends the data over bus 143 to memory 139. LSU 116 may load data from D-Cache 102 for use by the execution units (e.g., FXU 114).

SMT processor 150 has pipeline stages comprising circuitry of the IFU 108 and circuitry of the IDU 132 that is shared between two threads. Instructions are loaded into pipeline stages alternately from each thread in program order. As the instructions are accessed from I-Cache 104 they are queued in a T0 queue 135 and a T1 queue 136. Instructions are selected from these queues either equally or according to a thread priority selector 137 which selects from each thread substantially in proportions the thread's priority. An instruction sequencer 113 in the IDU 132 combines the instructions from each thread into instruction groups of up to five instructions per group as implemented in some PowerPC microprocessors. The instructions from the thread groups are issued to instruction issue queues 131 that feed multiple execution units (e.g., 114, 116, and 118). Instructions in the instruction groups are in program order when they are dispatched to instruction issue queues 131 and to the completion table (not shown) in completion unit 119. However, instructions may be issued to the execution units out-of-order.

When instructions are executing in an execution unit (e.g., FPU 118), there may be an exception condition (e.g., divide by zero in an FPU 118) that occurs that prevents the instruction from completing. If the instruction does not complete it may not release shared resources (e.g., group completion table entry). If this resource is needed by an instruction awaiting dispatch from dispatch stage 140, then that instruction may not be dispatched because of shared resource requirements.

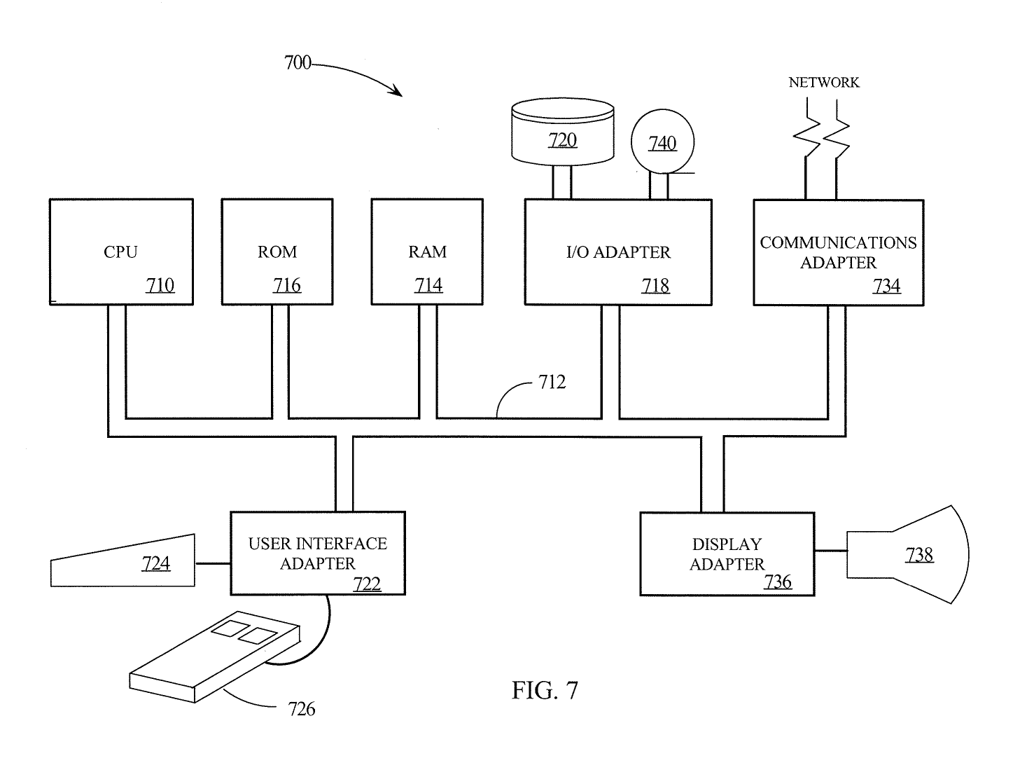

A representative hardware environment for practicing the present invention is depicted in FIG. 7, which illustrates a typical hardware configuration of a workstation in accordance with the subject invention having central processing unit (CPU) 710 with simultaneous multithread (SMT) processing (e.g., CPU 150) and a number of other units interconnected via system bus 712. The workstation shown in FIG. 7 includes random access memory (RAM) 714, read only memory (ROM) 716, and input/output (I/O) adapter 718 for connecting peripheral devices such as disk units 720 and tape drives 740 to bus 712, user interface adapter 722 for connecting keyboard 724, mouse 726, speaker 728, or other user interface devices such as a touch screen device (not shown) to bus 712, communication adapter 734 for connecting the workstation to a data processing network, and display adapter 736 for connecting bus 712 to display device 738.

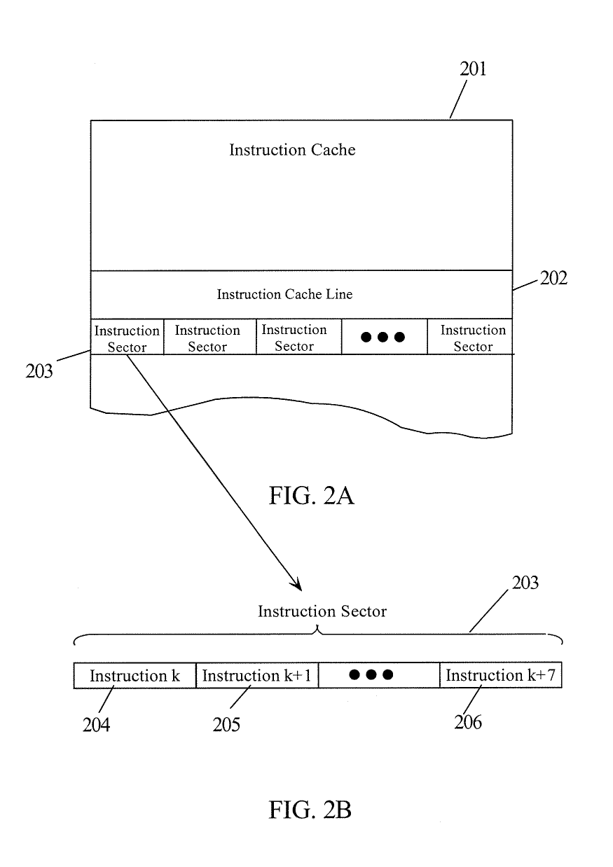

FIG. 2A illustrates an instruction cache (I-cache) 201 with a cache line 202. Each cache line 202 comprises a plurality of Instruction Sectors 203. Each of the Instruction Sectors 203 further comprises a sequence of 8 instructions, instruction k 204, instruction k+1 205 and instruction k+7 206 as shown in FIG. 2B.

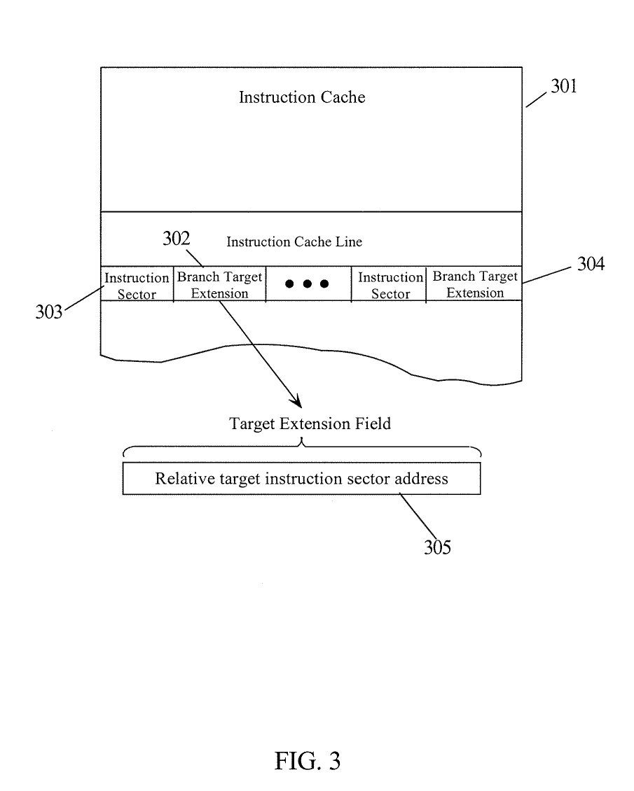

FIG. 3 shows a high level implementation used in one embodiment of the present invention. In this illustration, I-Cache 301 has cache lines 304 each containing a plurality of Instruction Sectors (e.g. 303) each extended to include a Branch Target Extension (e.g., 302). Each Branch Target Extension has an address field 304 for storing a relative branch target sector address 305.

During each cycle, an Instruction Fetch Unit (IFU) fetches one exemplary Instruction Sector 303 from the I-Cache 301. The corresponding relative branch target sector address 305 in Branch Target Extension 302 is also fetched. If there is a taken branch in Instruction Sector 303, then the relative branch target sector address 305 is used in the next cycle to fetch the Instruction Sector located at the target address 305.

In a current design, each exemplary Instruction Sector 303 contains 8 instructions and about two branch instructions on average. When executing the sequence of instructions in an Instruction Sector, a second branch instruction in the Instruction Sector is not processed if the first branch instruction is unconditional or predicted taken. With the Branch Target Extension 302, the relative branch target sector address 305 is available immediately for unconditional or predicted-taken branches, thereby resulting in zero cycle taken-branch delay.

A relative branch target sector address 305 may be updated when the target address for a taken branch in the associated Instruction Sector is available. This may occur either after the branch address calculation is finished, or when a taken branch as committed. This update requires the Branch Target Extension to be writeable from the execution engine. However, this path will not be critical as it is part of branch prediction update and similar to an Instruction Sector being writeable from L2 and read from the IFU.

While loading the instructions from an L2 cache to an L1 I-Cache, instructions may be pre-decoded. A compiler may take advantage of this implementation and generate branch target addresses to be stored in the Branch Target Extension 302 directly resulting in zero cycle delay for unconditional branches, even at the first occurrences. The compiler can also take advantage of this implementation and generate target extension usage hints.

In one embodiment of the present invention, the Branch Target Extension 302 simply contains a branch target sector address. During each instruction fetch, the branch target address extension is checked to see if it contains valid target sector address indicating that the exemplary Instruction Sector 303 contains an unconditional or likely-taken branch. Therefore, instruction fetch will start with the branch target sector address in the next cycle. With this embodiment, each branch target address is a target sector address, instead of a full address.

The present invention also alleviates the impact from simultaneous multithread (SMT) on the branch target address prediction. The branch target address prediction structure is decentralized and it is no longer necessary to maintain thread-specific structures.

In other embodiments of the present invention, the branch target address extension may contain branch prediction information to determine whether or not to use a branch target address. In this case, more than one target extension field is used to handle two or more branch instructions per Instruction Sector. Analysis has shown that on average an Instruction Sector with 8 instructions will on average have two branch instructions. Two Branch Target Extensions would be adequate to handle this case, however, it is understood that more than two Branch Target Extensions could be used per Instruction Sector.

As a rule of thumb, an exemplary architecture has on average 1 branch instruction for every 5 instructions. Since in an exemplary architecture there are 8 instructions per Instruction Sector, then there will be many Instruction Sectors that have two branch instructions. Using only one target address extension, then the choices when encountering two branch instructions in one Instruction Sector are to either use or not use the corresponding branch target address stored in a target address extension depending whether the branch is predicted taken. If the Instruction Sector has two associated Branch Target Extensions, then a relative branch target sector address may be stored in each Branch Target Extension wherein the target address in the first Branch Target Extensions is associated with the first branch instruction and the target address in the second Branch Target Extensions is associated with the second branch instruction.

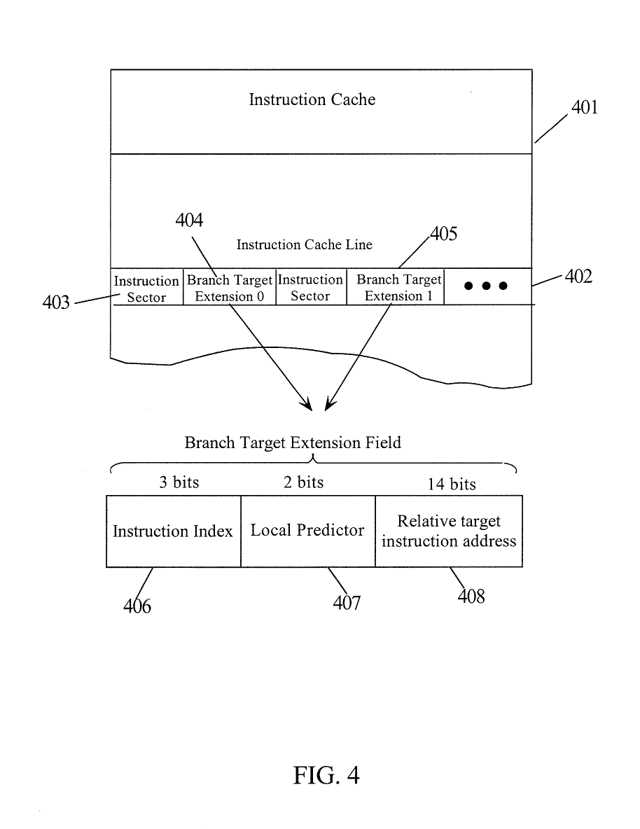

FIG. 4 shows a logical implementation for a target extension field used in multiple Branch Target Extensions 404 according to embodiments of the present invention. In this case, exemplary Instruction Sector 403 has 8 instructions and two Branch Target Extensions 404 and 405. Each of the target extension fields in Branch Target Extensions 404 and 405 is partitioned into a 3-bit instruction index field 406, a 2-bit local predictor field 407 and a 14-bit relative target address field 408. Relative target address 408 locates a branch target address within the I-Cache 401. The instruction index field 406 is used to locate the branch instructions within the 8 instructions in the Instruction Sector. It is useful when an instruction fetch is redirected to the middle of an Instruction Sector 403. The local predictor field 407 is used to indicate the predicted state of a corresponding branch instruction; predicted taken (including unconditional) and predicted not taken.

The local predictor field 407 may be a two-bit counter recording recent behavior of an associated branch instruction. For unconditional branches, the associated local predictor field 407 may be always binary (11) and thus always indicating that the branch is taken. Likewise, when the local predictor field 407 is a binary (10), it may be used to indicate that the branch is predicted taken. Therefore, when the local predictor field is binary (11) or (10), the associated branch target address in branch target address field 408 is used as a target instruction fetch address on the next clock cycle.

I-Cache 401 has 2 target address extensions (404 and 405) for each Instruction Sector on a cache line, each corresponding to a branch instruction (either conditional or unconditional) in the Instruction Sector 403. On each Instruction Sector fetch, the 3 least significant effective fetch address bits (fetch instruction address) are compared against instruction indexes 406 in each target address extension 404 and 405. This operation may be done in parallel. Likewise, the two local predictor fields 407 in each target address extension 404 and 405 are also checked to see whether or not the corresponding branch instruction is likely to be a taken branch. For example, assume target address extension 404 has an instruction index (Index 0) and target address extension 405 has an instruction index (Index 1). On an Instruction Sector fetch, the 3 least significant bits (fetch index) of a relative instruction address indicates where in the Instruction Sector instruction fetch starts. Thus the follow scenarios may occur:
1. The fetch index is smaller than Index 0. If local predictor 0 is binary (11) or (10) (branch unconditional or predicted taken), then the branch target address 0 (in target address extension 404) is used as a branch target fetch address. Otherwise, local predictor 1 is checked to see if it is likely to be a taken branch. If it is a predicted taken branch, then target address 1 (in target address extension 405) is used as a branch target fetch address.
2. The fetch index is larger than the Index 0 but smaller than or equal to Index 1. This happens when instruction fetch is redirected to the middle of the Instruction Sector, in between the two branch instructions. In this case, only local predictor 1 is checked since the branch instruction associated with target address extension 404 is not in the instruction sequence. If local predictor 1 determines its associated branch instruction is predicted taken, then the branch target address in target address extension 405 is used as a target fetch address.
3. The fetch index is larger than both Index 0 and Index 1. When this occurs, both target address extension fields are ignored since their associated branch instructions are not in the dynamic instruction sequence.

An effective fetch address is where instruction fetching starts. Instructions sectors are fetched from the I-Cache but the effective fetch address may indicate that fetching starts at an interior instruction. For example, in a particular 8-Instruction Sector, the least significant bits of the effective fetch address are (binary 100=4) meaning only instructions 4-7 are used. If this particular Instruction Sector had instruction 3 as an unconditional branch and instruction 6 as a conditional branch, then with two branch extensions the branch target address in the second extension would be the one needed. When using two branch extensions, then the instruction index for the first branch instruction (Index 0) would be 3 (instruction 3 is a branch) and the instruction index for the second branch extension (Index 1) would be 6 (instruction 6 is a branch). The 3 least significant bits of the effective fetch address indicate where instruction fetching starts in an Instruction Sector and thus comparison of the 3 least significant bits of the effective fetch address to the stored instruction indexes (Index 0 and Index 1) would indicate Index 0<4<Index 1 so the branch target address in the second branch extension would be used if the branch was predicted taken.

The Branch Target Extension (e.g., 404 or 405) may be further augmented with a bit indicating whether or not the associated branch instruction is a subroutine return and the target should be from the link stack. Essentially, the target prediction using the link stack is moved before the branch scan stage.

For pipelined I-Cache, a Branch Target Extension may be a separate structure and accessed using the same fetch address as does the I-Cache. It may also be a banked structure to accommodate more frequent accesses and updates.

Traditionally, each Instruction Sector may be aligned and scanned to find the control flow instructions (conditional or unconditional branches). Then based on the branch instructions, the direction and branch target addresses is predicted or calculated, resulting in delays for both conditional and unconditional taken branches. The present invention is different from other branch target address prediction designs because it eliminates the delays for scanning and address computation. In the present invention, once the fetch addresses is known, the predicted target addresses is available the next cycle.

An exemplary L1 I-Cache is 64 KB in size, 2-way set associative with a line size of (4×32) bytes (i.e., 4 cache sectors in each line). For one implementation, each of the 2K Instruction Sectors is associated with two target address extension fields each with 19 bits (or 38 bits in total). In this case, the added overhead to implement embodiments of the present invention would be 76 Kbits, or 14.8% of the I-Cache size.

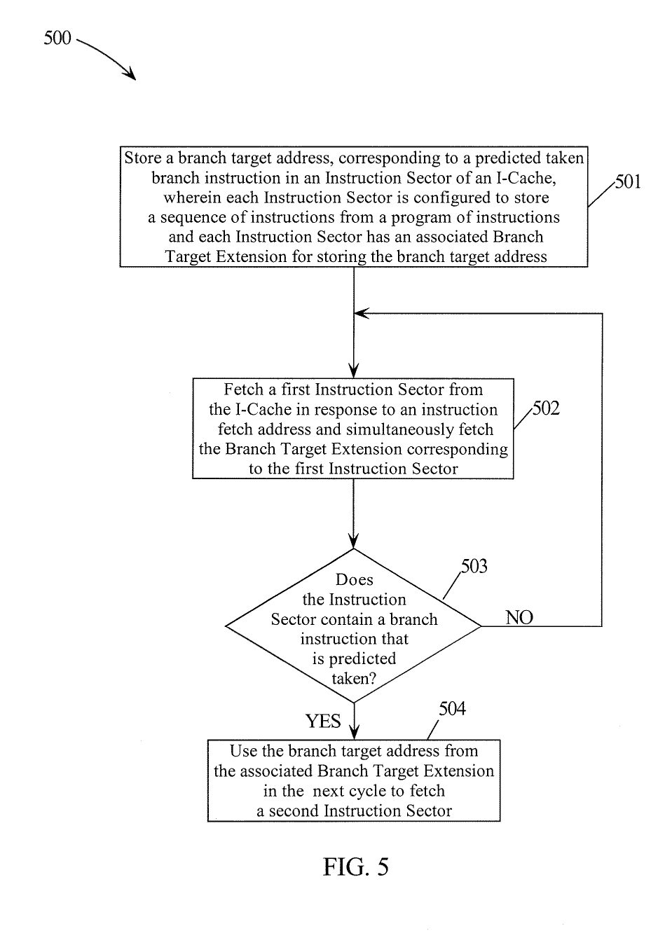

FIG. 5 is a flow diagram 500 of method steps used in embodiments of the present invention. In step 501, a branch target address is stored corresponding to a predicted taken branch instruction in an Instruction Sector of an I-Cache, wherein each Instruction Sector is configured to store a sequence of instructions from a program of instructions and each Instruction Sector has an associated Branch Target Extension for storing the branch target address. In step 502, a first Instruction Sector is fetched from the I-Cache in response to an instruction fetch address and the Branch Target Extension of the first Instruction Sector is simultaneously fetched. In step 503, a test is done to determine if the first Instruction Sector contains a branch instruction that is predicted taken. If the result of the test in step 503 is NO, then return back to step 502. If the result of the test in step 504 is YES, then in step 504 the branch target address in the Branch Target Extension of the first Instruction Sector is used in the next cycle to fetch a second Instruction Sector in the I-Cache.

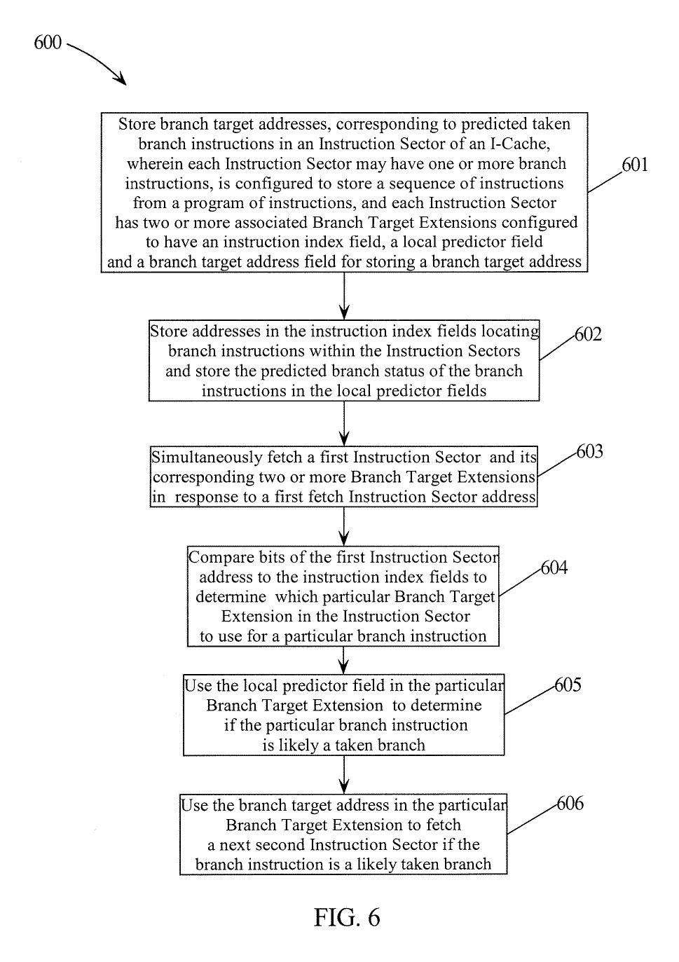

FIG. 6 is a flow diagram of steps used in another embodiment of the present invention. In step 601, branch target addresses are stored corresponding to predicted taken branch instructions in an Instruction Sector of an I-Cache, wherein each Instruction Sector may have one or more branch instructions, is configured to store a sequence of instructions from a program of instructions, and each Instruction Sector has two or more associated Branch Target Extensions configured to have an instruction index field, a local predictor field, and a branch target address field for storing one of the branch target addresses. In step 602, addresses for locating branch instructions within the Instruction Sectors are stored in the instruction index fields and data is stored in the local predictor fields indicating the predicted taken status of branch instructions in the Instruction Sectors. In step 603, a first Instruction Sector and its corresponding two or more Branch Target Extensions are fetched from the I-Cache in response to a program instruction fetch address. In step 604, bits of the program instruction address are compared to the bits in the instruction index fields to determine the particular Branch Target Extension to use. In step 605, the local predictor field of the particular Branch Target Extension is used to determine if the particular branch instruction in the Instruction Sector is predicted taken. In step 606, the branch target address in the particular Branch Target Extension is used to fetch a second Instruction Sector if the local predictor field indicates that the branch instruction associated with the particular Branch Target Extension is likely taken.

Although the present invention and its advantages have been described in detail, it should be understood that various changes, substitutions and alterations can be made herein without departing from the spirit and scope of the invention as defined by the appended claims.

What is claimed is:

1. A method for managing branch instructions:
retrieving a first Instruction Sector from an instruction cache (I-Cache) in response to an instruction fetch address;
retrieving, concurrent with the first Instruction Sector, a Branch Target Extension associated with the first Instruction Sector, wherein the I-Cache has a plurality of Instruction Sectors each configured to store a group of sequential instructions from a program of instructions; and
using a branch target address stored in the Branch Target Extension to fetch a second Instruction Sector in the I-Cache if a branch instruction in the first Instruction Sector is predicted taken.

2. The method of claim 1, wherein the Branch Target Extension is added to each of the plurality of Instruction Sectors within the I-Cache.

3. The method of claim 2 further comprising the step of storing the branch target address in the Branch Target Extension when a target address for a taken branch instruction in an associated Instruction Sector is available.

4. The method of claim 3, wherein the branch target address for the taken branch instruction in the associated Instruction Sector is available when the taken branch instruction is committed or when a branch address calculation for the taken branch instruction is finished.

5. The method of claim 1, wherein the branch target address is generated by a compiler.

6. The method of claim 5, wherein the branch target address is checked to determine it is valid indicating that the Instruction Sector contains an unconditional or likely taken branch instruction.

7. The method of claim 1, wherein each of the plurality of Instruction Sectors has a plurality of associated Branch Target Extensions each corresponding to a possible branch instruction and each partitioned into an instruction index field for storing a location of a branch instruction in a Instruction Sector, a local predictor field for storing a predicted taken status of a branch instruction in the Instruction Sector, and a target address field for storing the branch target address.

8. The method of claim 7, wherein binary bits of the instruction index field are compared to binary bits of an instruction fetch address to determine which Branch Target Extension to use for a particular branch instruction.

9. The method of claim 8, wherein the predicted taken status is used to determine if the particular branch instruction is a taken branch.

10. The method of claim 7, wherein the plurality of Branch Target Extensions are added to each Instruction Sector in the I-Cache.

11. A data processing system comprising
a central processing unit (CPU);
a random access memory (RAM) for storing a program of instructions and data;
an instruction cache memory (I-Cache) in the CPU for storing often used instructions; and
a bus for coupling the CPU the I-Cache, and the RAM, wherein the I-Cache is configured with a multiplicity of Instruction Sectors each for storing a group of instructions from the program of instructions and each having an associated Branch Target Extension for storing a branch target address corresponding to a branch instruction in an Instruction Sector that is predicted taken.

12. The data processing system of claim 11, further comprising circuitry for simultaneously fetching an Instruction Sector and its associated Branch Target Extension.

13. The data processing system of claim 11, wherein the Branch Target Extension is added to each of the plurality of Instruction Sectors in the I-Cache.

14. The data processing system of claim 11, further comprising circuitry for checking if a branch target address is valid indicating that a corresponding Instruction Sector contains an unconditional or likely taken branch instruction.

15. The data processing system of claim 11, wherein each of the plurality of Instruction Sectors has a plurality of associated Branch Target Extensions each corresponding to a possible branch instruction and each partitioned into an instruction index field for storing a location of a branch instruction in the Instruction Sector, a local predictor field for storing a predicted taken status of the branch instruction in the Instruction Sector, and a target address field for storing the branch target address.

16. The data processing system of claim 15, wherein binary bits of the instruction index field are compared to binary bits of an instruction fetch address to determine which Branch Target Extension to use for a particular branch instruction.

17. The data processing system of claim 16, wherein the predicted taken status is used to determine if the particular branch instruction is a taken branch.

18. The data processing system of claim 15, wherein the plurality of Branch Target Extensions are added to each Instruction Sector in the I-Cache.

19. The data processing system of claim 15, wherein the plurality of Branch Target Extensions associated with each of the Instruction Sectors are in a separate memory from the I-Cache.

20. The data processing system of claim 11, wherein the Branch Target Extensions associated with each of the Instruction Sectors are in a separate memory from the I-Cache.
